(19) United States
(12) Patent Application Publication
(10) Pub. No.: US 2016/0179065 A1
(43) Pub. Date: Jun. 23, 2016

(54) SMART FACILITY MANAGEMENT PLATFORM

(71) Applicant: ZAN Compute Inc., San Jose, CA (US)

(72) Inventor: Junaith Ahemed Shahabdeen, San Jose, CA (US)

(21) Appl. No.: 14/578,211

(22) Filed: Dec. 19, 2014

(51) Int. Cl. G05B 15/02; H04L 29/08; H04W 4/14; G06N 5/04

(52) U.S. Cl. CPC G05B 15/02; G06N 5/046; H04L 67/12; H04W 4/14; H04W 84/18

(57) ABSTRACT

A smart facility management platform (SFMP) includes wireless sensors installed in containers for waste disposals and containers holding supplies, so that the use status of these monitored containers may be automatically transmitted to a remote management service over a computer network, e.g., cloud service. Facility managers and supervisors may monitor the use status in real time and accordingly schedule on-demand cleanup operations, based on criteria set up in the SFMP. The SFMP may further have an event generation capability for notifying the supervisors and janitors through application programs running on mobile devices (“mobile apps”), SMS messages or email, when a service condition arises (e.g., garbage can fills up, towel dispenser runs out of towels, sensor has a low-battery condition, or any malfunction). In addition, the SFMP also allows better management of inventory for facility management companies and reduces wastage of supplies, such as garbage bags and air filters.

### BACKGROUND OF THE INVENTION

1. Field of the Invention

The present invention relates to automating facility management services. More particularly, the present invention relates to managing day-to-day janitorial tasks and heating, ventilation and air condition (HVAC) maintenance.

2. Discussion of the Related Art

Many janitorial services remain repetitive and menial. For example, in many commercial or industrial facilities, a janitorial professional manually and regularly checks the garbage cans and paper towel dispensers in bathrooms and refreshment areas, and provides services when needed. In addition, other maintenance services in such commercial or industrial facilities are also labor-intensive. For example, a service person regularly inspects and replaces air filters in the HVAC system. Such systems are both labor-intensive and intolerably inefficient. Many man-hours are wasted for unnecessary inspection trips, in addition to wastage of garbage bags, and air filters due to proactive policies of restocking such supplies before it becomes necessary.

Automation has occurred in specific areas in the cleaning industry mainly in recycling. See, for example, recycling service providers, e.g., RecycleSmart at http://recycle-smart.ca/(Enevo). The research paper, entitled “Waste Bin Monitoring System Using Integrated Technologies,” by K. Mahanjan and J. S. Chitode, published in the International Journal of Innovative Research in Science, Engineering and Technology, Vol. 3, Issue 7, July 2014, pp. 14953-57, describes remote monitoring of waste bins. However, these solutions are ad hoc and not integrated. Even though both RecycleSmart (Enevo) and the research paper discuss leveraging waste bins and recycle bins, neither addresses solutions pertaining to paper towel dispensers and air filters, which are key resources managed by a facility management company. The above solutions are mainly concerned with outdoor waste bins and optimizing the routes of garbage trucks, but do not address the janitorial problems inside a building.

### SUMMARY

The present invention eliminates the labor-intensive process of personally checking every single garbage bin in every single room in a building and allows the service provider to operate more effectively and efficiently.

According to one embodiment of the present invention, a smart facility management platform (SFMP) includes wireless sensors installed in containers for waste disposals and containers holding supplies, so that the use status of these monitored containers may be automatically transmitted by wireless communication to a remote management service over a computer network, e.g., a cloud service. Facility managers and supervisors may monitor the use status in real time and accordingly schedule on-demand cleanup operations, based on criteria that are set up in the SFMP.

In one embodiment, the SFMP has an event generation capability for notifying the supervisors and janitors through application programs running on mobile devices (“mobile apps”), SMS messages or email, when a condition requiring service arises (e.g., a garbage can fills up, a towel dispenser runs out of towels, a sensor has a low-battery condition, or any malfunction). In addition, the SFMP also allows better management of inventory for facility management companies and reduces wastage of supplies, such as garbage bags, and air filters.

The SFMP of the present invention takes advantage of the comprehensive infrastructure available over global computer data networks to provide additional services. For example, in one embodiment, a rules engine and a fusion module create flexible and practical solutions, which allow data aggregation over time. The aggregation data provides accurate assessments that are significantly valuable in inventory management.

The present invention is better understood upon consideration of the detailed description below in conjunction with the accompanying drawings.

### BRIEF DESCRIPTION OF THE DRAWINGS

FIG. 1 shows the building blocks of SFMP 100, in accordance with one embodiment of the present invention.

FIG. 2 illustrates SFMP 100's ability to combine data from multiple sensors that may be mounted on an air duct cover to determine current occupancy of a room and the temperature to be maintained, in accordance with one embodiment of the present invention.

### DETAILED DESCRIPTION OF THE PREFERRED EMBODIMENTS

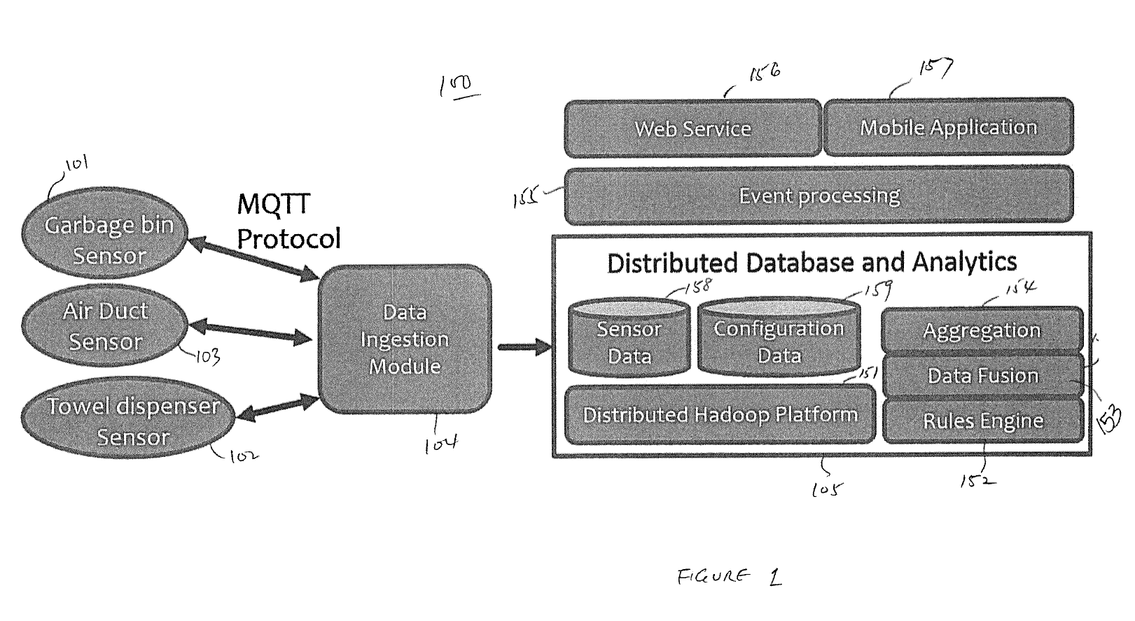

FIG. 1 shows the building blocks of SFMP 100, in accordance with one embodiment of the present invention. As shown in FIG. 1, SFMP 100 receives data input from a number of sensors, exemplified here by garbage bin sensors 101, towel dispenser sensors 102, and air duct sensors 103. One or more of the garbage bin sensors, towel dispenser sensors and air duct sensors may be housed in a sensing device that is capable of wireless communication (e.g., over WiFi or the cellular telephone system) with a data collection module (“data ingestion module”) 104, which forwards the collected data to data management and analysis system 105. Wireless communication may be conducted, for example, using the MQ telemetry transport (MQTT) protocol. Details regarding MQTT protocols may be obtained, for example, from its sponsoring organization, at http://mqtt.org/. Each sensing device may be equipped with a microprocessor and a wireless communication integrated circuit for receiving sensor data from the sensors and transmitting the data to data ingestion module 104. The sensing device may be provided a capability for adaptively adjusting the sampling and transmission intervals to conserve power without affecting system functionality.

In one embodiment, two types of battery-operated garbage bin sensing devices may be provided. For example, some garbage bin sensing devices may be provided with a reflective infra-red (IR) range finder or an ultrasonic range finder. One example of a suitable reflective infra-red range finder may be the GP2D120 sensor from Sharp Corporation, Japan. The range finder may be mounted on the cover of a garbage bin. The range finder detects the distance or proximity of the garbage in the bin relative to the position of the sensor to thereby determine the level of fullness. The range finder on the cover of the garbage bin typically sends out an IR or ultrasonic beam and detects its reflection. The round-trip transit time (“time of flight”) is measured to determine a distance.

Alternatively, a pressure sensor may be provided in a garbage sensing device installed at the bottom of a garbage bin. One example of such a pressure sensor is a force sensing resistor (FSR), such as any of those described in “Force Sensing Resistor Integration Guide and Evaluation Parts Catalog,” available from the Interlink Electronics, Camarillo, Calif. The pressure sensor may be mounted underneath any garbage bin. The pressure sensor detects a weight change to determine the amount of garbage in the bin, and hence its fullness level. The pressure sensor approach is suitable for garbage bins that are not provided a top cover or lid, e.g., many recycle bins in office areas. An FSR sensor exhibits a change in resistance in response to a change in weight.

One suitable garbage bin configured to support a facility management system (e.g., SFMP 100 above) is described, for example, in co-pending patent application (“Smart Garbage Bin Application” by the same inventor, entitled “Smart Garbage Bin,” filed on the same day as the present application. The disclosure of the Smart Garbage Bin Application is hereby incorporated herein by reference in its entirety.

In addition to detecting the amount of garbage in a garbage bin, additional sensors may be provided in the garbage bin. For example, sensors that detect noxious gases may be provided for safety and air freshness monitoring. For example, hydrogen sulfide gas, ammonia and methane gases may be detected by the MQ series semiconductor gas sensors, available from Hanwei Electronics Co., Ltd, Zhengzhou, China. The presence of such noxious gases indicates at least the presence of foul-smelling garbage in the garbage can, and may trigger an alarm condition in the back-end cloud service. The back-end cloud service is discussed in greater detail below.

According to one embodiment of the present invention, each sensing device housing a towel dispenser sensor may be battery-operated and tracks the amount of paper towels left in a towel dispenser. The towel dispenser sensor may include many photo sensors and light-emitting diodes (“LEDs”). The LEDs may be placed in vertically spaced intervals on one side of the inside of a towel dispenser and the photo sensors are correspondingly placed and aligned to the photo sensors on the opposite side of the towel dispenser, with the paper towels being provisioned between the photo sensors and the LEDs. In this manner, as the towel rolls shrinks in size through usage, successively more photo sensors detect light from their respective corresponding LEDs, thereby allowing the towel dispenser sensor to detect the remaining amount of paper towels. Other types of photo sensor placements and LED alignments may also be suitable for detecting changes in the amount of paper towels, depending on whether the paper towels are provided in a roll or provided in a stack. A similar sensor design is possible for toilet paper dispensers. Alternatively, an Infrared transmitter and a corresponding receiver may replace an LED and an associated photo sensor, respectively, to achieve a similar result.

According to one embodiment of the present invention, an air duct sensing device with various sensors (e.g., a passive infra-red (PIR) occupancy sensor, a temperature sensor and a dust sensor) may be placed on an air duct cover. The PIR occupancy sensor tracks room occupancy. The temperature sensor (i.e., a thelinometer) tracks the local temperature of the room. The dust sensor tracks dust or particulate concentration in the air passing into the room through the air duct. One example of a suitable dust sensor is the GP2Y1010AU0F optical dust sensor, available from Sharp Corporation, Japan. In addition, the temperature sensor and the occupancy sensor allow the sensing device to monitor the occupancy pattern of the room and to adjust the temperature accordingly, so as to optimize energy usage. The dust sensor detects the changing dust level in the system to alert at the appropriate time a need for an air filter change or, in general, to report the air quality in the building to the facility managers. One suitable air duct sensing device is described in co-pending patent application (“Smart Air Duct Cover Application”) by the same inventor, entitled “Smart Air Duct Cover,” filed on the same day as the present application. The disclosure of the Smart Air Duct Cover Application is hereby incorporated herein by reference in its entirety.

Returning to FIG. 1, data ingestion module 104 and data management and analysis 105 provide a cloud service that is built upon a horizontally scalable cloud platform. The scalabilty in such a platform allows accommodation of data from many (even millions) sensor devices, without compromising good performance with respect to user querying, data aggregating and interaction with sensor devices.

As mentioned above, according to one embodiment of the present invention, the cloud platform uses the open-source MQTT protocol, which is a machine-to-machine (“M2M”) or “Internet of Things” connectivity protocol designed to be a lightweight publish-or-subscribe messaging transport. MQTT is particularly suited for providing connections to remote locations where a small code footprint is required or where network bandwidth is at a premium. Under the MQTT protocol, the sensor devices serve as “publishers.” As shown in FIG. 1, data ingestion module 104 serves as a “subscriber” or “broker” which receives data from all sensors, which controls the message flow between the publishers and the subscriber, and which stores the received sensor data into data management and analysis system 105, which may be implemented by a distributed data management system. FIG. 1 shows sensor data module 158 storing the received sensor data.

According to one embodiment of the present invention, a suitable platform for implementing data management and data analytics in data management and analysis system 105 is exemplified by open-source Hadoop platform 151, which may include an Apache HBASE database and a large data set analytics system Apache SPARK. The Apache HBASE database and the Apache SPARK system are described in details at http://hbase.apache.org/ and https://spark.apache.org/, respectively. These systems are designed to allow the database and the analytics system to be horizontally scalable across multiple servers and to maintain system performance.

According to one embodiment of the present invention, data management and analysis system 105 includes “rules engine” 152 which allows facility managers and supervisors to easily set rules and triggers for events. In one embodiment, many types of rules may be provided, from simple if-then-else to more sophisticated rules. In an if-then-else type rule, a user can set a threshold and can define what happens if the value from a sensor goes above or below a certain value. For example, if the garbage level exceeds 70%, a cleanup is triggered; otherwise, monitoring continues. More sophisticated rules may include rules emerging from machine learning or artificial intelligence (AI) algorithms, using data that have been processed in data fusion module 153, aggregation module 154, or both. In these more sophisticated data processing modules, the rules are formulated in a data pipeline, where the data flows through different processing steps in the pipeline before final output. From these more sophisticated rules, data output may be an insight from observing data pattern or an event. Data fusion module 153 and aggregation module 154 are the data processing cores of the SFMP platform, which combine data from multiple sensors to make intelligent decisions about maintenance functionalities. These rules may trigger an “event” that requires a human or a machine to be notified or to respond.

Event processing module 155 forwards events to appropriate notification or responding parties. For example, an event corresponding to cleaning certain garbage bins may be sufficiently urgent to require a facility manager to be notified by a mobile phone alert and by email. Event processing module 155 receives that event from rules engine 152 or data fusion module 153 and is responsible for sending the alert to a mobile telephone or by email. Email notification may be achieved using open-source mail servers (e.g., Dovecot or Postfix), MQTT and Java Spring for handing the delivery part of the event. As shown in FIG. 1, these events may also be forwarded to allow access through web service 156 or to mobile application 157.

According to one embodiment of the present invention, SFMP platform 100 includes configuration data module 159, which allows data management and analysis system 105 to be configured with specific rules, for specifying parameter values for its intended operations, or to reconfigure from time to time to meet varying system demands.

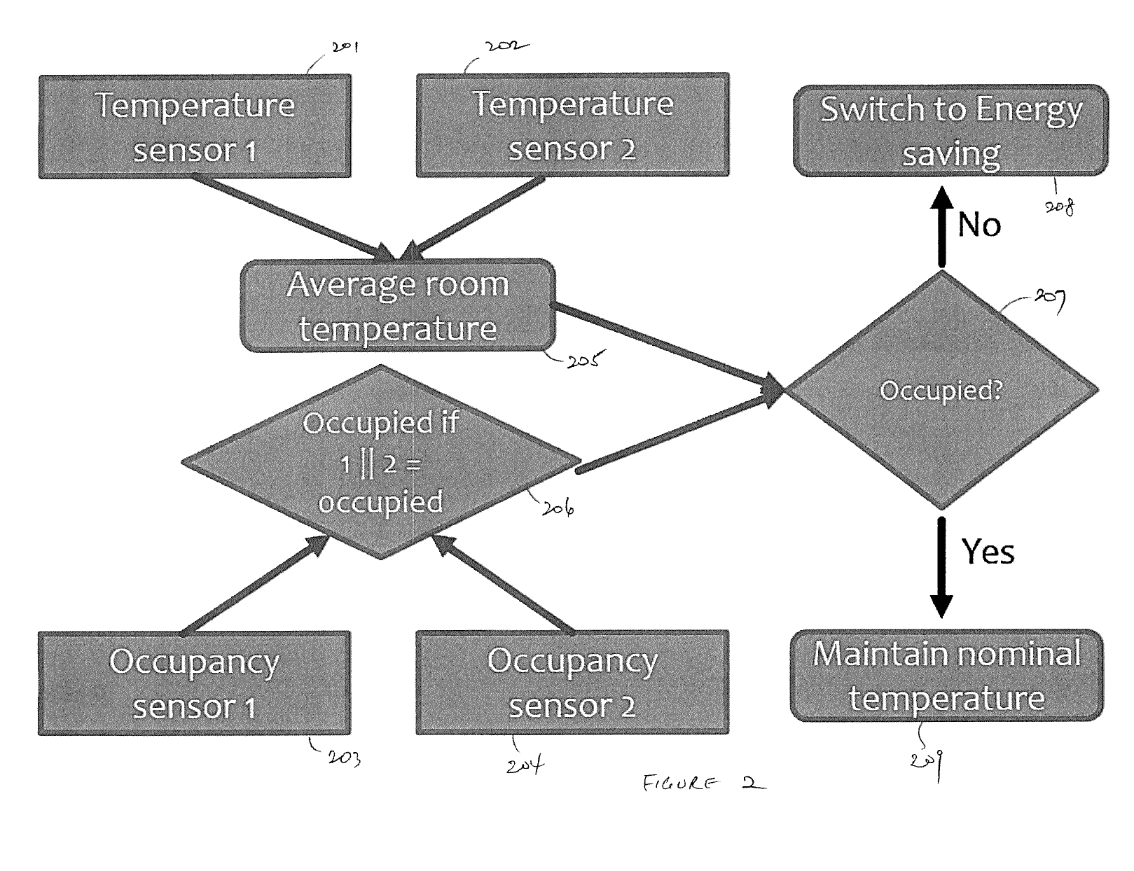

FIG. 2 illustrates, as part of a decision-making process in SFMP 100 using input from multiple sensors 201-204, which may be mounted on a air duct cover, to determine current occupancy of a room and the temperature to be maintained, in accordance with one embodiment of the present invention. As shown in FIG. 1, a sensor device (e.g., an air duct cover) includes temperature sensors 201 and 202 and occupancy sensors 203 and 204. Software running on a microprocessor in the server device computes from the temperature readings of temperature sensor 201 and 202 an average temperature in the room (step 205). At the same time, occupancy sensors 203 and 204 detect if the room where these sensors are installed is occupied. Software running on the microprocessor of the sensor device also determines the current occupancy of the room (step 206). The software running on the microprocessor takes into consideration both the current temperature and the current occupancy to determine whether a preset temperature setting should be maintained (step 207). If the software determines that the room is not occupied, then the preset temperature of the room is not maintained (energy savings mode, step 208). Otherwise, the preset temperature for the room is maintained (209).

In one embodiment, SFMP 100 aggregates in aggregation module 154 sensor data from multiple dust sensors in air ducts located in various zones of a building. The aggregated data is used to provide a zone-level dust estimation in fusion module 153. Zone-level data dust estimates may be analyzed for insights and actions to be taken into environmental conditions (e.g., prevalence of dust particles in PM2.5 or PM10 sizes) in commercial, industrial or residential buildings in dusty areas.

In one embodiment, SFMP 100 sends action required alerts (e.g., “empty garbage bin”) to maintenance personnel, when triggered by one of multiple preset conditions (e.g., “garbage bin full” or “noxious odor detected”).

The above detailed description is provided to illustrate specific embodiments of the present invention and is not intended to be limiting. Numerous variations and modifications within the scope of the present invention are possible. The present invention is set forth in the accompanying claims.

I claim:

1. A system for facility management, comprising:
a plurality of sensor devices each capable of transmitting sensor data or operational status information over wireless communication;
a data collection module receiving the sensor data or the operational status information from each of the sensor devices over wireless communication; and
a data management and analysis system communicating with the data collection module over a wide-area computer network, comprising:
a distributed management system for storing the sensor data or operational status information received in the data collection module and for storing configuration data that define facility management operations; and
a data analysis module for analyzing the stored data in the distributed management system and creating system events based on the facility management operations defined by the configuration data.

2. The system of claim 1, wherein the sensor devices comprise one or more sensors installed in garbage bins, one or more sensors installed in dispensers of supplies, and one or more environmental sensors.

3. The system of claim 2 wherein the supplies comprise toilet paper, air filters or paper towels.

4. The system of claim 2, where in the sensors installed in garbage bins comprise pressure sensors, range sensors, and sensors for detecting gaseous chemicals.

5. The system of claim 2, wherein the environmental sensors comprise dust sensors, thermometers, and air flow sensors.

6. The system of claim 1, wherein the distributed data management system further comprises a user interface for user query of sensor data and for a user to provide the configuration data.

7. The system of claim 6, wherein the user interface allows the user to schedule maintenance events.

8. The system of claim 6, wherein the user interface comprises a web service.

9. The system of claim 1, wherein the data analysis module comprises an aggregation module for combining sensor data from selected sensors or sensor types.

10. The system of claim 1, wherein the aggregation module uses the aggregated sensor data for inventory management.

11. The system of claim 1, wherein the data analysis module comprises a fusion module for combining sensor data or operational status information from multiple sources and acting thereupon to generate the alerts.

12. The system of claim 1, further comprising an event processing module that determines an appropriate action for each system event created.

13. The system of claim 12, wherein the appropriate action requires some system events to send alerts to facility management personnel to take action.

14. The system of claim 13, wherein the alerts are sent over email, short messages or through an application program running on a mobile device.

15. The system of claim 1, wherein the wireless communication between the sensor devices and the data collection module uses a light-weight communication protocol.

16. The system of claim 1, wherein the light-weight communication protocol comprises the MQTT protocol.

17. The system of claim 1, wherein the data analysis module comprises a rules module that creates system events based on pre-configured rules.
